(19) United States
(12) Patent Application Publication
(10) Pub. No.: US 2012/0180671 A1
(43) Pub. Date: Jul. 19, 2012

(54) CONTAINER HOLDING ASSEMBLY AND RECEIVING ASSEMBLY ADAPTED FOR CONNECTING A CONTAINER TO A MACHINE

(75) Inventors: Larry Sacha Baudet, Preverenges (CH); Lucio Scorrano, Yverdon-les-Bains (CH)

(73) Assignee: NESTEC S.A., Vevey (CH)

(21) Appl. No.: 13/497,400

(22) PCT Filed: Sep. 9, 2010
(86) PCT No.: PCT/EP2010/063233

§ 371 Date: Mar. 21, 2012

(30) Foreign Application Priority Data
Sep. 23, 2009 (EP) 09171130.9

(51) Int. Cl. A47J 31/00; B23P 11/00; B65B 1/04; B65D 43/26; B65D 41/20; B65D 25/20; B65D 25/38

(52) U.S. Cl. 99/295; 220/23.9; 29/428; 141/311 R; 141/383; 141/1

(57) ABSTRACT

The invention concerns a container holding assembly (1) configured and adapted to connect a container (3) adapted for storing and unloading a powder material to a machine, said container (13) comprising: (a) a vessel (31) presenting a closed end (34) and an opened end (35), (b) a hopper (32) placed inside the vessel (31) and tapering to a discharge outlet in direction of the vessel opened end, (c) a tearable membrane (33) closing the hopper and the vessel and a corresponding receiving assembly (2) of the machine configured and adapted to receive the container holding assembly (1).

The present invention relates to a method for securing a disposable powder tank to a machine processing doses of powder distributed from the tank.

WO 2009/000810 describes a container for storing and unloading a powder material that comprises:
a vessel presenting a closed end and an opened end,
a hopper placed inside the vessel and tapering to a discharge outlet in direction of the vessel opened end,
a tearable membrane closing the hopper and the vessel.

This container can be used to refill the tank of a machine, in particular a machine producing beverages by dilution of the powder stored in the container. This container can also be used as the expansion tank of a machine. Actually if the machine presents a small internal tank or no tank at all, the container can be placed in the machine and provide the function of a tank or an expansion tank above the machine.

Yet it has been noticed that the simple installation of the container in the machine is not sufficient to prevent the movement of the container during the time it is positioned in the machine; for example, the machine operator could inadvertently push the container which could unload its powder out of the machine opening.

It has also been noticed that the operator may orientate the container along a bad direction when he connects the container to the machine. There is a need for a more direct and immediate connection of the container to the machine so that the operator immediately places the container along the correct direction.

The present invention aims at solving these problems.

According to a first aspect, the invention concerns a container holding assembly configured and adapted to connect a container adapted for storing and unloading a powder material to a machine,
said container comprising:
   a vessel presenting a closed end and an opened end,
   a hopper placed inside the vessel and tapering to a discharge outlet in direction of the vessel opened end,
   a tearable membrane closing the hopper and the vessel.
said machine comprising a receiving assembly configured and adapted to receive the container holding assembly, said receiving assembly comprising means for piercing the tearable membrane of the container and for cooperating with the hopper of the container, wherein the container holding assembly comprises a holding vessel presenting a closed end and an opened end, said holding vessel:
presenting a shape and a size such that the container vessel is able to totally fit inside that holding vessel,
comprising guiding and locking means at its opened end for matching corresponding guiding means and locking means of the receiving assembly,
comprising releasing means at its closed end for withdrawing the container from the holding vessel.

Preferably the holding vessel presents a shape and a size such that at least a part of the container is slightly compressed by at least a part of the holding vessel. Consequently, once the container is placed inside the holding vessel, the assembly of the container in the holding vessel can be manipulated without the container falling or sliding out of the holding vessel. A wall friction is created between the container and the holding vessel that prevents the sliding of the container. Yet this wall friction is insufficient to resist to a simple human manual force pushing the container out of the holding vessel.

The guiding and locking means of the container holding assembly is preferably a tongue but any other known guiding and locking means could be used like e.g. corresponding screw threads on the holding vessel opened end and on the receiving assembly.

According to an embodiment, the releasing means of the container holding assembly can be an opening able to let a finger slide inside. The operator can slide a finger in that opening to push the container vessel out of the holding vessel.

According to another embodiment, the closed end of the holding vessel can also be made at least partially of a soft material so that the operator can exert a force on the container vessel through the soft material at the closed en of the holding vessel.

According to another embodiment, the closed end of the holding vessel can also present a hole in which a piston is able to slide. The length of the piston must be sufficient to enable the displacement of the extremity of the container vessel opened end out of the holding vessel of the receiving assembly so that the operator can grab it and draw it out.

The holding vessel is generally made of a rigid material. It is preferably made of plastic or metal to provide an aesthetic aspect.

According to a second aspect, the invention concerns a receiving assembly configured and adapted to receive the container holding assembly such as described above comprising:
guiding means to guide the container holding assembly,
locking means to lock the container holding assembly,
means for piercing the tearable membrane of the container and for cooperating with the hopper of the container.

The means for piercing the tearable membrane of the container and for cooperating with the hopper of the container is preferably a conduit presenting a section smaller than the section of the opened of the container vessel and bigger than the section of the hopper discharge outlet. The outlet section of the conduit presents generally a symmetrical form preferably a circular form. It can present a specific form cooperating exactly with the discharge outlet of the hopper. Due to these relative section differences:
the conduit can fit into the container vessel opened end when piercing the container membrane and
the discharge outlet of the hopper can fit into the conduit, which enables the bulk material to directly flow from the container through the hopper to the machine without contact with the air.

According to the preferred mode, the guiding means of the receiving assembly guide the container holding assembly according to an axially aligned configuration respectively to the axis of the conduit and the axis of the of the hopper discharge outlet. Then the both axis of the hopper discharge outlet and of the conduit overlap and the membrane can be regularly torn along its entire surface permitting an efficient emptying of the container.

The guiding means of the receiving assembly can be a vertical slit. Said vertical slit can match with a tongue of the container holding assembly so that the tongue slides along the slit.

The locking means of the receiving assembly can be a horizontal slit. According to the preferred embodiment of the present invention, the receiving assembly comprises a vertical slit to guide the container holding assembly and a horizontal slit to lock the container holding assembly, the horizontal slit communicating with the bottom end of the vertical slit. These two slits enable easy coupling of the container holding assembly in the receiving assembly according to a first vertical downward movement to slide the tongue in the vertical slit and a second horizontal movement to slide the tongue in the horizontal slit.

As mentioned above other guiding and locking means can be implemented like for example screw threads along the holding assembly and the receiving assembly.

According to a third aspect, the invention concerns a dispensing machine which comprises a receiving assembly such as described above and a flowable substance dosing assembly at the bottom of said receiving assembly. Actually the invention is particularly adapted to machines fed with powders. The dosing assembly of the machine receives and transports a predetermined amount of flowable substance to part of the machine that processes this substance. The dosing assembly can be a rotary auger driven by an electrically powered motor.

Preferably, the dispensing machine can produce beverages. The flowable substance is accordingly a powdered food or beverage, like coffee, milk-based powder, chocolate, soup, soluble tea, . . .

According to a fourth aspect, the invention concerns a method for connecting a container for storing and unloading a powder material to a machine,
said container comprising:
   a vessel presenting a closed end and an opened end,
   a hopper placed inside the vessel and tapering to a discharge outlet in direction of the vessel opened end,
   a tearable membrane closing the hopper and the vessel.
said machine comprising means for piercing the tearable membrane of the container and for cooperating with the hopper of the container and a receiving assembly such as described above, said method comprising the steps of:
introducing the container inside the holding vessel of a container holding assembly such as described above, the closed end of the container vessel facing the closed end of the container holding assembly,
positioning the container holding assembly in the machine so that the guiding and locking means of said container holding assembly matches with the guiding means and the locking means of the receiving assembly.

According to a fifth aspect, the invention concerns a system for producing beverages comprising:
a container adapted for storing and unloading a powder material, said container comprising:
   a vessel presenting a closed end and an opened end,
   a hopper placed inside the vessel and tapering to a discharge outlet in direction of the vessel opened end,
   a tearable membrane closing the hopper and the vessel,
a machine for preparing beverages from a powder material comprising a receiving assembly, said receiving assembly comprising means for piercing the tearable membrane of the container and for cooperating with the hopper of the container,
a container holding assembly presenting a shape and a size such that the container vessel is able to totally fit inside that holding vessel and comprising:
   at least one guiding and locking means at its opened end for matching corresponding guiding means and locking means of the machine receiving assembly,
   comprising releasing means at its closed end for withdrawing the container from the holding vessel.

### BRIEF DESCRIPTION OF THE DRAWINGS

The characteristics and advantages of the invention will be better understood in relation to:

FIGS. 1 and 2 respectively depict an exploded view and a section view of the flowable powder container used in the present invention.

FIG. 3 depicts an exploded view of the container holding assembly and the receiving assembly of the present invention.

FIG. 4 depicts side and section views the flowable powder container, the container holding assembly and the receiving assembly assembled together during the dispensing of the flowable powder.

### DETAILED DESCRIPTION OF THE DRAWINGS

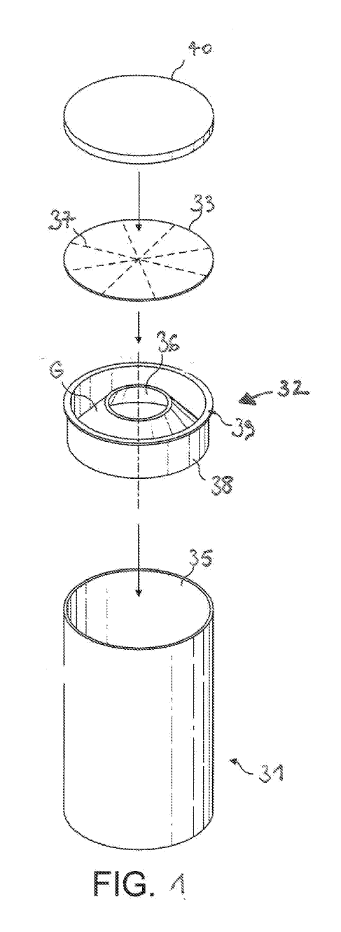

FIG. 1 illustrates a container 3 used in the context of the present invention for storing a flowable powder and able to refill a machine. It comprises a vessel 31 that is here a rigid cylinder presenting a closed end 34 and an opened end 35. The container 3 comprises a hopper 32 positioned inside the vessel volume and near to the opened end 35 of the vessel 31. Said hopper extends on the whole vessel section and tapers to a discharge outlet 36 that faces the opened end 35 of the vessel. The hopper is attached to a circular skirt or outside flange 38 which presents the same form as the internal wall of the vessel 31. This skirt fits inside the vessel 31 and helps positioning the hopper in the vessel. This skirt presents a stopping edge 39 that abuts against the vessel opened end edge and avoids the hopper sliding along the vessel wall. Due to the fact that the hopper is placed inside the vessel volume with its discharge outlet facing the vessel opened end, a groove G extends between the hopper tapering wall and the vessel wall along all the periphery of the hopper discharge outlet.

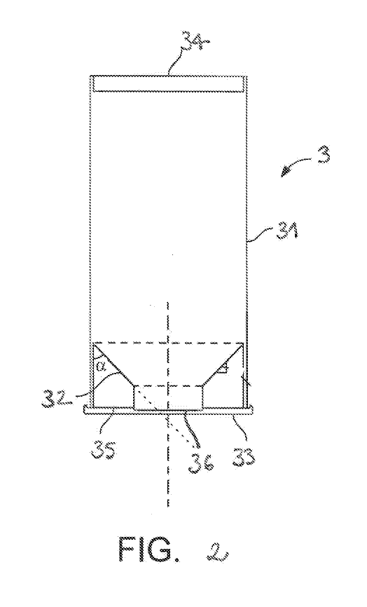

A tearable membrane 33 is fixed above the opened end 35 of the vessel 31 and above the hopper discharge outlet 36 closing simultaneously the vessel opened end and the hopper tapered end. Preferably, the membrane is tearable by exercising a contact pressure on its surface. Such a tearable function can be obtained by making small perforations 37 (see FIG. 2) through the membrane. Then the membrane can present tear lines, for example straight lines intersecting at the centre of the membrane. The membrane 33 may be made of any material that is tearable, this can be at least a material chosen between: paper, aluminium and polymer sheets. Lastly a protective cap 40 can be placed above the tearable membrane 33 in order to prevent the tearing of the membrane before the container is used for unloading its content.

FIG. 2 is a section view of the container 3 showing the relative position of the different components.

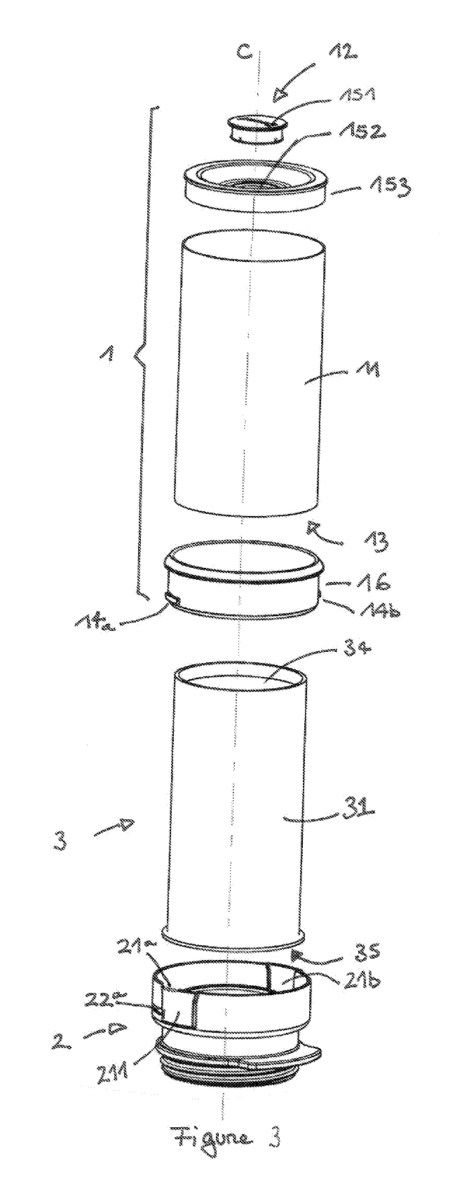

FIG. 3 depicts in its upper part an exploded view of the container holding assembly 1. This assembly comprises a rigid holding vessel 11 presenting an opened end 13 and a closed end 12, said end being closed by a pierced cover 153 presenting a hole 152 that is closed by a piston 151. The combination of the pierced hole 152 and the piston 151 forms releasing means for withdrawing the container 3 from the holding vessel 11 when the container holding assembly 1 is disconnected from the receiving assembly 2. The centre part of the pierced cover 153 can be recessed inside the holding vessel volume so that the upper part of the piston 151 does not stand higher than the end of the vessel 11 when the container 3 is put in place inside the holding vessel 11.

The shape and the size of the holding vessel 11 are such that the container vessel 31 is able to totally fit inside that holding vessel. Once the container vessel 31 is slid in the holding vessel 11, no part of the container vessel 31 can be seen. The container holding assembly 1 comprises a ring 26 placed around the holding vessel 11 and near its opened end 13. This ring supports two guiding and locking means of the container holding assembly 1 which are made of two tongues 14a, 14b extending radially and outwardly from the holding vessel surface. The different parts of the container holding assembly 1 may be connected by permanent or detachable means. Permanent means may be designed to be sealing, welding, bonding, non-reversible clipping means or other means. Detachable means may mean an assembly formed of a threaded portion or equivalent complementary mechanical engagement means on one of the elements of the assembly which collaborate with a threaded portion or complementary mechanical engagement means belonging to another element of the assembly.

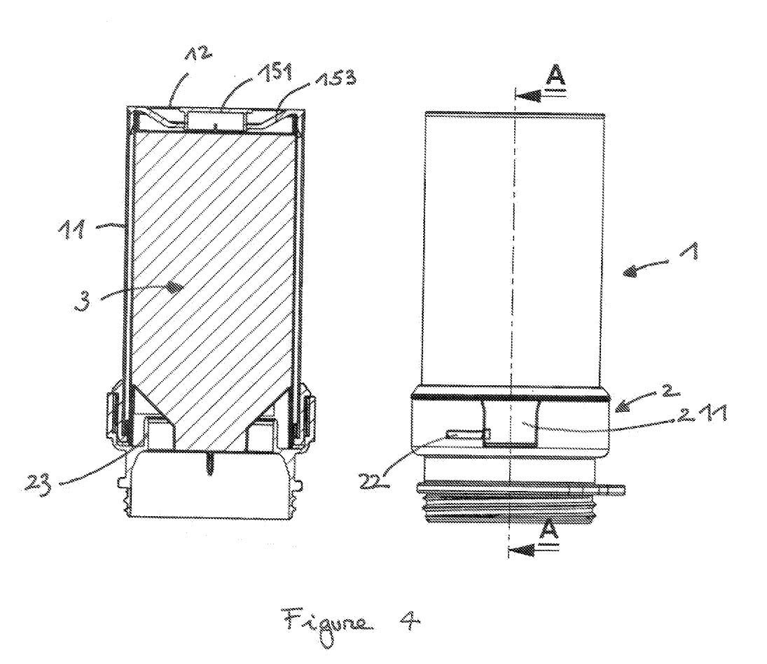

The receiving assembly 2 presents the same circular shape as the container holding assembly 1 so that it can receive said container holding assembly 1 inside. It presents two vertical slits 21a, 21b on the periphery of its ring shape to match with the two tongues 14a, 14bof the container holding assembly 1 in order to guide it vertically. Optional external peripheral covers 211 hide these vertical slits 21a, 21 b in the embodiment of FIGS. 3 and 4. Due to these corresponding guiding means 14a, 14b, 21a, 21b, the container holding assembly 1 perfectly orientates the container 11 so that it is vertically pushed against the means 23 for piercing the tearable membrane of the container and for cooperating with the hopper of the container hired in the receiving assembly 2 (see FIG. 4). Due to the guiding means, the centre axis of the container 3 and of the receiving assembly 2 align themselves on the same axis C. The tearable membrane (not represented in FIGS. 3 and 4) of the container 3 is quickly torn and its torn pieces are well moved apart from the opened mouth of the hopper.

Further to this downward movement that opens the tearable membrane of the container 3, the operator can lock the container holding assembly 1 with the container 3 inside by horizontally rotating the container holding assembly 1 so that the both tongues 14a, 14b slide inside the horizontal slides 22a of the receiving assembly 2 which avoids the inadvertent withdrawing of the container holding assembly 1 from the receiving assembly 2. Actually, when the container 3 acts as the main or expansion tank of the machine, the whole flowable substance is not totally poured inside the machine once the container holding assembly 1 and the receiving assembly 2 are connected together. An amount of powder flows immediately in the receiving assembly 2 and for example in the dosing means at the bottom of said receiving assembly but the rest stays inside the container 3 and is gradually removed from it by the dosing means. It is important to not withdraw the container holding assembly 1 before the container 3 is totally empty. If not, the flowable substance would flow out of the container during the withdrawing and messes up the machine. Then the operator should not disconnect the two assemblies 1, 2 before he is sure that the container is empty; this can be checked for example through little transparent superposed parts of the container 3 and the container holding assembly 1 near their opened ends area. The emptiness can also be controlled by an optical sensor or by counting the number of doses that have flowed through the dosing means. The locking means oblige the operator to ask himself if the container holding assembly 1 can be removed.

The receiving assembly 2 can present means for attaching it to a machine to be fed with the flowable substance. In FIGS. 3 and 4, these means are threaded screws. The means 23 for piercing the tearable membrane of the container and for cooperating with the hopper of the container 3 (see FIG. 4) is a conduit of which upward section is greater than the section of the hopper discharge outlet and smaller than the opened end of the container vessel 31. The downward section of this conduit is attached to the internal periphery of the receiving assembly 2.

1. Container holding assembly designed to be connected to a container adapted for storing and supplying a powder material to a machine,
the container comprising:
a vessel having a closed end and an opened end,
a hopper located inside the vessel and tapering to a discharge outlet in a direction of the vessel opened end,
a tearable membrane closing the hopper and the vessel,
the machine comprising a receiving assembly designed to receive the container holding assembly, the receiving assembly comprising a member for piercing the tearable membrane of the container and for cooperating with the hopper of the container,
the container holding assembly comprises a holding vessel having a closed end and an opened end,
the container vessel is able to totally fit inside the holding vessel,
the holding vessel including at least one guiding and lock member at its opened end for matching a corresponding guide and lock member of the receiving assembly, and
the holding vessel having a release at a closed end for removing the container from the holding vessel.

2. Container holding assembly according to claim 1 wherein the guide and lock member is a tongue.

3. Container holding assembly according to claim 1 wherein the release is an opening that can receive a finger.

4. Container holding assembly according to claim 1 wherein the closed end of the holding vessel is at least partially made of a soft material.

5. Container holding assembly according to claim 1, wherein the closed end of the holding vessel defines a hole in which a piston is able to slide.

6. Container holding assembly according to claim 1, wherein the holding vessel is made of plastic or metal.

7. Receiving assembly configured and adapted to receive a container holding assembly configured and adapted to be connected to a container adapted for storing and unloading a powder material to a machine, the container comprising: a vessel having a closed end and an opened end, a hopper located inside the vessel and tapering to a discharge outlet in direction of the vessel opened end, a tearable membrane closing the hopper and the vessel, the machine comprising a receiving assembly designed to receive the container holding assembly, the receiving assembly comprising a member for piercing the tearable membrane of the container and for cooperating with the hopper of the container, the container holding assembly comprises a holding vessel having a closed end and an opened end, the holding vessel, the container vessel is able to totally fit inside the holding vessel, the holding vessel comprising at least one guiding and a lock member at its opened end for matching corresponding guide and lock member of the receiving assembly and a release at its closed end for removing the container from the holding vessel comprising:
at least one guide to guide the container holding assembly,
at least one lock to lock the container holding assembly, and
a member for piercing the tearable membrane of the container and for cooperating with the hopper of the container.

8. Receiving assembly according to claim 7, wherein the member for piercing the tearable membrane of the container and for cooperating with the hopper of the container is a conduit.

9. Receiving assembly according to claim 7, wherein the guide guides the container holding assembly along an axial direction with respect to the axis of the conduit and the axis of the of the hopper discharge outlet.

10. Receiving assembly according to claim 7 wherein the guide of the receiving assembly is a vertical slit.

11. Receiving assembly according to claim 7 wherein the lock of the receiving assembly is a horizontal slit.

12. Dispensing machine which comprises a receiving assembly designed to be connected to a container adapted for storing and unloading a powder material to a machine, the container comprising: a vessel having a closed end and an opened end, a hopper located inside the vessel and tapering to a discharge outlet in direction of the vessel opened end, a tearable membrane closing the hopper and the vessel, the machine comprising a receiving assembly designed to receive the container holding assembly, the receiving assembly comprising a member for piercing the tearable membrane of the container and for cooperating with the hopper of the container, the container holding assembly comprises a holding vessel having a closed end and an opened end, the holding vessel having a shape and a size such that the container vessel is able to totally fit inside that holding vessel, comprising at least one guiding and a lock member at its opened end for matching corresponding guide and lock member of the receiving assembly, and comprising a release at its closed end for withdrawing the container from the holding vessel, and a dosing assembly at the bottom of the receiving assembly.

13. Dispensing machine according to claim 10 for producing beverages.

14. Method for connecting a container for storing and unloading a powder material to a machine,
the container comprising:
a vessel having a closed end and an opened end,
a hopper placed inside the vessel and tapering to a discharge outlet in direction of the vessel opened end,
a tearable membrane closing the hopper and the vessel,
the machine comprising a piercing member for piercing the tearable membrane of the container and for cooperating with the hopper of the container and a receiving assembly
comprising the steps of:
introducing the container inside a holding vessel of a container holding assembly, the closed end of the container vessel facing the closed end of the container holding assembly, and
positioning the container holding assembly in the machine so that a guiding and locking member of the container holding assembly matches with a guiding and locking member of the receiving assembly.

15. System for producing beverages comprising:
a container adapted for storing and unloading a powder material, the container comprising:
a vessel comprising a closed end and an opened end,
a hopper located inside the vessel and tapering to a discharge outlet in direction of the vessel opened end,
a tearable membrane closing the hopper and the vessel,
a machine for preparing beverages from a powder material comprising a receiving assembly, the receiving assembly comprising a piercing member for piercing the tearable membrane of the container and for cooperating with the hopper of the container,
a container holding assembly comprising a shape and a size such that the container vessel is able to totally fit inside that holding vessel and comprising:
at least one guiding and locking member at its opened end for matching corresponding guiding and locking member of the machine receiving assembly, and
comprising a release at its closed end for withdrawing the container from the holding vessel.
